(19) United States
(12) Patent Application Publication
(10) Pub. No.: US 2026/0346687 A1
(43) Pub. Date: Nov. 5, 2026

(54) METHOD FOR OPERATING AN ELECTRIC VIEWING ELEMENT ARRANGEMENT

(71) Applicant: Brose Fahrzeugteile SE & Co. Kommanditgesellschaft, Bamberg, Bamberg (DE)

(72) Inventors: Thomas LIEDTKE, Eisenach (DE); Gerhard FISCHER, Weißenbrunn (DE); Bernd HERTHAN, Michelau (DE); Fabian ENGLER, Bamberg (DE)

(21) Appl. No.: 19/488,445

(22) PCT Filed: May 31, 2024
(86) PCT No.: PCT/EP2024/064973

§ 371 Date: Nov. 26, 2025

(30) Foreign Application Priority Data
Jun. 1, 2023 (DE) 102023114459.6

(51) Int. Cl. B60J 3/04; G02F 1/133

(52) U.S. Cl. CPC B60J 3/04; G02F 1/13306

(57) ABSTRACT

A method for operating an electric viewing element arrangement, in particular a window arrangement, of a motor vehicle, wherein the viewing element arrangement has at least one transparent viewing element, the degree of transparency of which is variable, and a control unit, wherein the viewing element is controlled by means of the control unit in order to set the degree of transparency thereof. The control unit measures an electrical parameter of the viewing element in a defect detection routine and, on the basis of the electrical parameter, determines whether a defect of the viewing element exists.

The present invention relates to a method for operating an electric viewing element arrangement in accordance with the preamble of claim 1, a control unit for an electric viewing element arrangement according to the preamble of claim 13, an electric viewing element arrangement according to the preamble of claim 14 and a motor vehicle having an electric viewing element arrangement according to claim 15.

The known prior art (DE 10 2012 014 788A1) from which the invention is based relates to a method in accordance with the preamble of claim 1. The motor vehicle in question has a viewing element arrangement having a viewing element in the form of a window arrangement, the degree of transparency of which can be varied by applying a control voltage via a control unit. Such viewing elements are also called smart glass. Such a setting of the degree of transparency can be advantageous, for example, in the sense of a dimming function.

Such viewing elements are often operated with higher voltages, which is why they can become a danger to the occupants in the event of a crash, for example. Glass can also be damaged outside of crash situations. Actuation of a damaged viewing element is usually not desirable. If it can or should nonetheless take place, at least the damage should be responded to. In any case, it can be stated that detecting damage to a viewing element would be advantageous.

The invention is based on the object of configuring and further developing the known method in such a way that further optimization is achieved with regard to the above challenge.

The above object is achieved by the features of the characterizing part of claim 1.

It is significant that the fundamental consideration is that it is possible to electrically detect damage to an electric viewing element by evaluating an electrical parameter of the viewing element.

In detail, it is proposed that the control unit measure an electrical parameter of the viewing element in a defect detection routine and, on the basis of the electrical parameter, determine whether a defect in the viewing element exists.

In a preferred embodiment in accordance with claim 2, the viewing element is a smart glass whose transparency can be varied by applying a control voltage. Preferably, the smart glass is self-dimming.

In accordance with claim 3, the viewing element can be controlled by means of direct or alternating voltage and can act electrically as a capacitor. The electrical parameter is then preferably an impedance or capacitance.

In order to determine the electrical parameter, in accordance with claim 4, a system response of the viewing element can be determined if it is subjected to current or voltage. Claims 5 and 6 specify variants of how the system response can be actively triggered. In accordance with claim 5, a control voltage that is used anyway can be used for this purpose, whereby the method can be implemented particularly efficiently. In accordance with claim 6, a dedicated diagnostic voltage or diagnostic current can also be used instead.

Claim 7 specifies possibilities as to when the diagnostic routine is advantageously performed. Claim 8 relates to possible responses to a detected defect.

Claims 9 to 12 relate to various embodiments of the determination of the electrical parameter and its compensation with regard to an ambient temperature or an aging of the viewing element.

In accordance with a further teaching according to claim 13, which has independent significance, a control unit for an electric viewing element arrangement is claimed.

A significant aspect is that the control unit measures an electrical parameter of the viewing element in a defect detection routine and, on the basis of the electrical parameter, determines whether a defect in the viewing element exists.

Reference may be made to all statements relating to the proposed method.

In accordance with a further teaching according to claim 14, which also has independent significance, an electric viewing element arrangement is claimed.

A significant aspect is that the control unit measures an electrical parameter of the viewing element in a defect detection routine and, on the basis of the electrical parameter, determines whether a defect in the viewing element exists.

Reference may be made to all statements relating to the proposed method and the proposed control unit.

According to a further teaching in accordance with claim 15, which also has independent significance, a motor vehicle having a proposed electric viewing element arrangement is claimed.

Reference may be made to all statements relating to the proposed method, the proposed control unit and the proposed electric viewing element arrangement.

In the following, the invention is explained in more detail with reference to a drawing that merely represents exemplary embodiments. In the drawing:

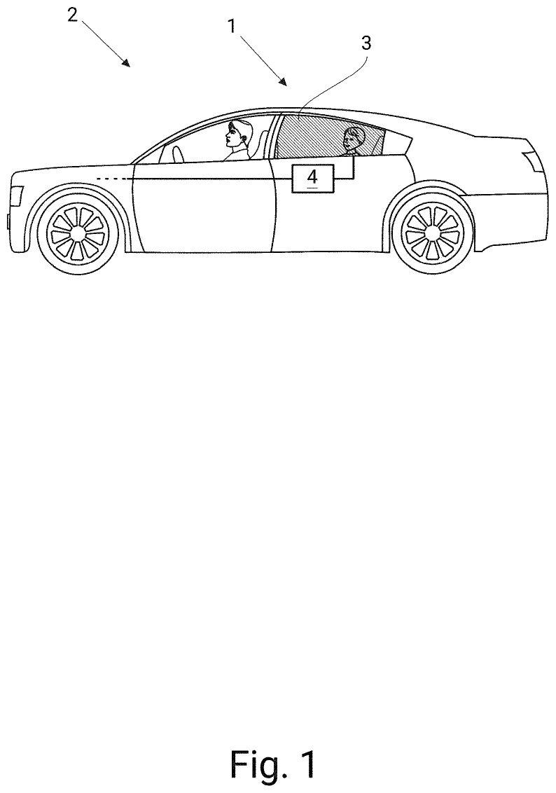

FIG. 1 shows a motor vehicle having a proposed viewing element arrangement,

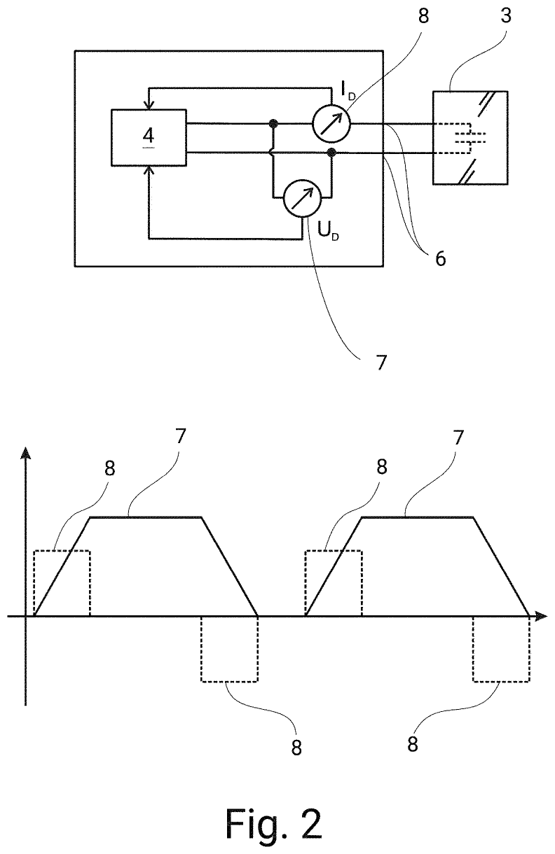

FIG. 2 schematically shows a circuit of the viewing element and the control unit above and an exemplary diagnostic current and voltage profile, and

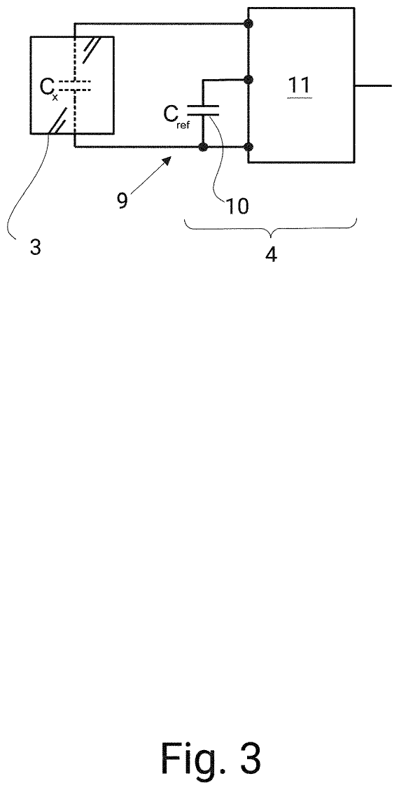

FIG. 3 shows a schematic comparison circuit.

The exemplary embodiment shown in the figures and thus preferred relates to a method for operating an electric viewing element arrangement 1, in particular a window arrangement, of a motor vehicle 2. The viewing element arrangement 1 has at least one transparent viewing element 3, the degree of transparency of which is variable, and a control unit 4. The viewing element 3 can in principle be any window of a motor vehicle 2, in particular a rear side window or a roof window. The viewing element 3 can in particular be dimmed or lightened. FIG. 1 shows by way of example a motor vehicle 2 having a viewing element 3 in the form of a rear side window. Alternatively, the viewing element can also be a mirror.

The viewing element 3 is controlled by means of the control unit 4 in order to set the degree of transparency thereof, in particular by generating a control voltage and applying it to the viewing element 3.

It is now significant that the control unit 4, in a defect detection routine, measures an electrical parameter of the viewing element 3 and, on the basis of the electrical parameter, determines whether a defect in the viewing element 3 exists. Such a defect could be a manufacturing defect, broken glass, a stone chip or the like. Preferably, the defect is a defect of at least 5%, in particular at least 10%, of the area of the viewing element 3. Therefore, the defect can be caused in particular by a crash. “Measuring” in the present context generally means any metrological determination, in particular an indirect determination from measured quantities.

Furthermore, it is preferably provided here that the viewing element 3 is designed as a switchable smart glass, the degree of transparency of which can be set by applying a control voltage. Specifically, an implementation is preferably provided as an SPD (suspended particle device) glass, which can be controlled with an alternating voltage having a voltage value preferably between 0 V and 200 V, more preferably between 50 V and 150 V and more preferably between 90 V and 110 V. Alternatively, the viewing element 3 is preferably designed as LC (liquid crystal) glass, in particular as PDLC (polymer disperse liquid crystal) glass. Here, an alternating voltage having a voltage value preferably between 0 V and 80 V, more preferably between 30 V and 70 V and more preferably between 40 V and approximately 50 V is provided for actuation.

In a particularly preferred embodiment, the arrangement is such that a maximum degree of transparency can be generated exclusively by applying a control voltage, which is not a zero voltage, to the viewing element 3. Furthermore, it is then preferable that in the absence of control voltage a correspondingly reduced degree of transparency exists. It is then preferably a self-dimming glass.

FIG. 2 schematically shows a circuit of the viewing element 3 having the control unit 4. As can be seen, it is preferably the case that the viewing element 3 is equipped with control voltage terminals 5 for applying the control voltage designed as a direct or alternating voltage. The viewing element 3 preferably acts as a capacitance on the control voltage terminals 5. Accordingly, a capacitor is shown in FIG. 2 as a simplified equivalent circuit diagram of the viewing element 3. The electrical parameter can generally be an impedance, in particular a capacitance, of the viewing element 3. The electrical parameter is preferably measured between the control voltage terminals 5.

In the defect detection routine, it is preferably provided that the control unit 4 applies an electrical current or an electrical voltage to the viewing element 3 and determines the electrical parameter from a system response of the viewing element 3 to the electrical current or the electrical voltage. The system response can be measured as current and/or voltage or derived therefrom, as shown in FIG. 2. The system response can comprise a frequency of a current and/or a voltage and/or a current-voltage curve or the like. By way of example, two measuring points 6 for current and voltage are shown in FIG. 2 as part of the control unit 4.

In one exemplary embodiment, it is provided that the electrical voltage is the control voltage. In this way, a check for defects can be carried out directly in a simple manner when the electric viewing element 3 is activated or deactivated.

Changes in the control voltage are particularly suitable for determining electrical parameters, which is why it is preferably provided that the control unit 4, in the defect detection routine, determines the electrical parameter from a system response of the viewing element 3 to an increase and/or a decrease in the control voltage.

Here and preferably, the increase in the control voltage is a, in particular linear, voltage increase of the control voltage, in particular from 0 V and/or to a maximum voltage. For example, upon one or each activation of the control voltage, a measurement of the electrical parameter is carried out by the control unit 4.

As an alternative or in addition, the decrease of the control voltage is a, in particular linear, voltage decrease of the control voltage, in particular from a maximum voltage and/or to 0 V. It is conceivable to carry out the measurement both during activation and deactivation and to combine the results in order to increase the accuracy of the determination of the electrical parameter.

As an alternative to the use of the control voltage, it is possible that the electrical voltage can be a diagnostic voltage 7 that is independent of the control voltage or superimposed on the control voltage. This variant is particularly flexible. Here, a diagnostic voltage 7, which is preferably trapezoidal or rectangular, is applied to the viewing element 3 and the system response, here in the form of the diagnostic current 8, is measured. In principle, the profile of the control voltage could look similar. It is also conceivable that the electrical current is a diagnostic current 8 that is independent of the control voltage. The profile in FIG. 2 is only to be understood by way of example. It can also be provided that at times the control voltage and at other times a dedicated diagnostic voltage 7 is used and, preferably, that the results of the measurements are combined in order to increase the accuracy of the determination of the electrical parameter.

Preferably, in the defect detection routine, the control unit 4 determines the electrical parameter from a system response of the viewing element 3 to an increase and/or a decrease in the diagnostic voltage 7 or the diagnostic current 8.

There are various conceivable triggers for performing the diagnostic routine. It can be provided that the control unit 4 initially performs the diagnostic routine after assembly of the viewing element 3. Depending on the assembly, terminals, production and the like, it can be advantageous to initialize an initial capacitance of the viewing element 3 in the sense of a calibration.

The control unit 4 can additionally or alternatively carry out the diagnostic routine periodically when the control voltage is applied. In this way, a defect is quickly detected. The control unit 4 can also perform the diagnostic routine when the motor vehicle 2 is started and/or an ignition is activated.

Also interesting is a variant according to which the control unit 4 performs the diagnostic routine in response to a crash, in particular a signal from a crash sensor. It is preferably provided that the viewing element 3, in response to a crash, in particular a signal from a crash sensor, is brought into a secured state, in particular is de-energized. If it is a self-dimming viewing element 3, it is preferably dimmed afterwards. In order to support rescue workers, it can be provided that the control unit 4 switches the viewing element 3 to transparent in response to a crash if the control unit 4 does not detect a defect.

Furthermore, it is preferably provided here that the control unit 4, in response to a detected defect, outputs a signal to a user and/or logs the defect and/or adapts the control voltage, in particular reduces or deactivates it, and preferably deactivates a reactivation of the control voltage.

With reference to FIG. 3, it can be provided that the control unit 4 has a comparison circuit 9, in particular having a comparison capacitance 10. In FIG. 3, this is shown only very schematically together with a microcontroller 11 of the control unit 4. In the defect detection routine, the control unit 4 preferably compares an electrical parameter, in particular a capacitance, of the comparison circuit 9 having the electrical parameter of the viewing element 3 and, on the basis of the comparison, determines whether a defect in the viewing element 3 exists. By means of such a comparison circuit 9, various environmental influences, in particular temperature influences, can be reduced, since the comparison circuit 9 preferably responds similarly to environmental influences. It is further preferably provided that the control unit 4, on the basis of the comparison, determines whether a defect in the control unit 4 exists.

It is also conceivable that the control unit 4 compares the electrical parameter with a stored target value of the electrical parameter in the defect detection routine and, on the basis of the comparison, determines whether a defect in the viewing element 3 is present. Such a stored target value can simply be a specified capacitance of the viewing element 3. Preferably, however, the stored target value is temperature-dependent and/or dependent on the age of the viewing element 3.

It can also be provided that the control unit 4 applies a compensation parameter to the electrical parameter that takes into account the age of the viewing element 3 and, based on the thus compensated electrical parameter, determines whether a defect in the viewing element 3 exists, and/or that the control unit 4 compares the electrical parameter with past measurements of the electrical parameter in the defect detection routine and, on the basis of the comparison, determines whether a defect in the viewing element 3 exists. Preferably, the control unit 4 determines the compensation parameter from the past measurements. In this way, a gradual change in the capacitance due to aging can be compensated.

Furthermore, it is preferably provided here that the control unit 4 determines an environmental parameter, in particular an ambient temperature, and, based on the environmental parameter, applies a compensation parameter to the electrical parameter and, based on the thus compensated electrical parameter, determines whether a defect in the viewing element 3 exists.

In accordance with a further teaching, a control unit 4 is proposed for an electric viewing element arrangement 1, in particular a window arrangement, of a motor vehicle 2, in particular for performing the proposed method, wherein the viewing element arrangement 1 has at least one transparent viewing element 3, the degree of transparency of which is variable, and the control unit 4, wherein the viewing element 3 is controlled by means of the control unit 4 in order to set the degree of transparency thereof.

According to this further teaching, it is significant that the control unit 4 measures an electrical parameter of the viewing element 3 in a defect detection routine and, on the basis of the electrical parameter, determines whether a defect of the viewing element 3 exists.

Reference may be made to all statements relating to the proposed method.

In accordance with a further teaching, an electric viewing element arrangement 1, in particular a window arrangement, of a motor vehicle 2, in particular for performing a proposed method, is proposed, wherein the viewing element arrangement 1 has at least one transparent viewing element 3, the degree of transparency of which is variable, and the control unit 4, wherein the viewing element 3 is controlled by means of the control unit 4 in order to set the degree of transparency thereof.

According to this further teaching, it is significant that the control unit 4 measures an electrical parameter of the viewing element 3 in a defect detection routine and, on the basis of the electrical parameter, determines whether a defect of the viewing element 3 exists.

Reference may be made to all statements relating to the proposed method and the proposed control unit 4.

In accordance with a further teaching, a motor vehicle 2 having a proposed electric viewing element arrangement 1 is proposed.

Reference may be made to all statements relating to the proposed method, the proposed control unit 4 and the proposed electric viewing element arrangement 1.

1. A method for operating an electric viewing element arrangement, in particular a window arrangement, of a motor vehicle, wherein the viewing element arrangement has at least one transparent viewing element, the degree of transparency of which is variable, and a control unit, wherein the viewing element is controlled by means of the control unit in order to set the degree of transparency thereof, wherein the control unit measures an electrical parameter of the viewing element in a defect detection routine and, on the basis of the electrical parameter, determines whether a defect of the viewing element exists.

2. The method according to claim 1, wherein the viewing element is designed as a switchable smart glass, the degree of transparency of which can be set by applying a control voltage, preferably in that a maximum degree of transparency can be generated exclusively by applying a control voltage to the viewing element.

3. The method according to claim 1, wherein the viewing element is equipped with control voltage terminals for applying the control voltage designed as a direct or alternating voltage, preferably in that the viewing element acts as a capacitance on the control voltage terminals, and/or in that the electrical parameter is an impedance, in particular a capacitance, of the viewing element, in particular measured between the control voltage terminals.

4. The method according to claim 1, wherein the control unit applies an electrical current or an electrical voltage to the viewing element in the defect detection routine and determines the electrical parameter from a system response of the viewing element to the electrical current or the electrical voltage, preferably in that the electrical voltage is the control voltage, further preferably in that the control unit determines the electrical parameter from a system response of the viewing element to an increase and/or a decrease in the control voltage in the defect detection routine.

5. The method according to claim 4, wherein the increase in the control voltage is a, in particular linear, voltage increase of the control voltage, in particular from 0 V and/or to a maximum voltage, and/or in that the decrease in the control voltage is a, in particular linear, voltage decrease of the control voltage, in particular from a maximum voltage and/or to 0 V.

6. The method according to claim 1, wherein the electrical voltage is a diagnostic voltage that is independent of the control voltage or superimposed on the control voltage, or in that the electrical current is a diagnostic current that is independent of the control voltage, preferably in that the control unit in the defect detection routine determines the electrical parameter from a system response of the viewing element to an increase and/or a decrease in the diagnostic voltage or the diagnostic current.

7. The method according to claim 1, wherein the control unit performs the diagnostic routine when a transparency change of the viewing element is triggered by a user, and/or in that the control unit initially performs the diagnostic routine after assembly of the viewing element, and/or in that the control unit periodically performs the diagnostic routine when the control voltage is applied, and/or in that the control unit performs the diagnostic routine when the motor vehicle is started and/or an ignition is activated, and/or in that the control unit performs the diagnostic routine in response to a crash, in particular a signal from a crash sensor, preferably in that the control unit, in response to a crash, switches the viewing element to transparent if the control unit does not detect a defect.

8. The method according to claim 1, wherein the control unit, in response to a detected defect, outputs a signal to a user and/or logs the defect and/or adapts the control voltage, in particular reduces or deactivates it, and preferably deactivates a reactivation of the control voltage.

9. The method according to claim 1, wherein the control unit has a comparison circuit, in particular having a comparison capacitance, in that the control unit in the defect detection routine compares an electrical parameter, in particular a capacitance, of the comparison circuit with the electrical parameter of the viewing element and, on the basis of the comparison, determines whether a defect in the viewing element exists, further preferably in that the control unit, on the basis of the comparison, determines whether a defect in the control unit exists.

10. The method according to claim 1, wherein the control unit compares the electrical parameter with a stored target value of the electrical parameter in the defect detection routine and, on the basis of the comparison, determines whether a defect in the viewing element is present.

11. The method according to claim 1, wherein the control unit applies a compensation parameter to the electrical parameter that takes into account the age of the viewing element and, based on the thus compensated electrical parameter, determines whether a defect in the viewing element exists, and/or, in that the control unit compares the electrical parameter with past measurements of the electrical parameter in the defect detection routine and, on the basis of the comparison, determines whether a defect in the viewing element exists, preferably in that the control unit determines the compensation parameter from the past measurements.

12. The method according to claim 1, wherein the control unit determines an environmental parameter, in particular an ambient temperature, and, based on the environmental parameter, applies a compensation parameter to the electrical parameter and, based on the thus compensated electrical parameter, determines whether a defect in the viewing element exists.

13. A control unit for an electric viewing element arrangement, in particular a window arrangement, of a motor vehicle, in particular for performing the method according to claim 1, wherein the viewing element arrangement has at least one transparent viewing element, the degree of transparency of which is variable, and the control unit, wherein the viewing element is controlled by means of the control unit in order to set the degree of transparency thereof, wherein the control unit measures an electrical parameter of the viewing element in a defect detection routine and, on the basis of the electrical parameter, determines whether a defect of the viewing element exists.

14. An electric viewing element arrangement, in particular a window arrangement, of a motor vehicle, in particular for performing the method according to claim 1, wherein the viewing element arrangement has at least one transparent viewing element (3), the degree of transparency of which is variable, and the control unit, wherein the viewing element is controlled by means of the control unit in order to set the degree of transparency thereof, wherein the control unit measures an electrical parameter of the viewing element in a defect detection routine and, on the basis of the electrical parameter, determines whether a defect of the viewing element exists.

15. A motor vehicle having an electric viewing element arrangement according to claim 14.

16. The method according to claim 2, wherein the viewing element is equipped with control voltage terminals for applying the control voltage designed as a direct or alternating voltage, preferably in that the viewing element acts as a capacitance on the control voltage terminals, and/or in that the electrical parameter is an impedance, in particular a capacitance, of the viewing element, in particular measured between the control voltage terminals.

17. The method according to claim 2, wherein the control unit applies an electrical current or an electrical voltage to the viewing element in the defect detection routine and determines the electrical parameter from a system response of the viewing element to the electrical current or the electrical voltage, preferably in that the electrical voltage is the control voltage, further preferably in that the control unit determines the electrical parameter from a system response of the viewing element to an increase and/or a decrease in the control voltage in the defect detection routine.

18. The method according to claim 2, wherein the control unit applies an electrical current or an electrical voltage to the viewing element in the defect detection routine and determines the electrical parameter from a system response of the viewing element to the electrical current or the electrical voltage, preferably in that the electrical voltage is the control voltage, further preferably in that the control unit determines the electrical parameter from a system response of the viewing element to an increase and/or a decrease in the control voltage in the defect detection routine.

19. The method according to claim 2, wherein the electrical voltage is a diagnostic voltage that is independent of the control voltage or superimposed on the control voltage, or in that the electrical current is a diagnostic current that is independent of the control voltage, preferably in that the control unit in the defect detection routine determines the electrical parameter from a system response of the viewing element to an increase and/or a decrease in the diagnostic voltage or the diagnostic current.

20. The method according to claim 3, wherein the electrical voltage is a diagnostic voltage that is independent of the control voltage or superimposed on the control voltage, or in that the electrical current is a diagnostic current that is independent of the control voltage, preferably in that the control unit in the defect detection routine determines the electrical parameter from a system response of the viewing element to an increase and/or a decrease in the diagnostic voltage or the diagnostic current.
